(19) United States
(12) Patent Application Publication
(10) Pub. No.: US 2015/0257962 A1
(43) Pub. Date: Sep. 17, 2015

(54) HANDS-FREE BALL MASSAGE DEVICE

(71) Applicant: Eric Shannon, Boulder, CO (US)

(72) Inventor: Eric Shannon, Boulder, CO (US)

(21) Appl. No.: 14/203,914

(22) Filed: Mar. 11, 2014

(51) Int. Cl. A61H 1/00; A61H 15/00

(52) U.S. Cl. CPC A61H 1/008; A61H 15/0078; A61H 2201/1669

(57) ABSTRACT

One embodiment of a massage device (1) constructed of plastic, foam, rubber, cork or similar material, which allows the user (8) to perform a hands-free deep tissue massage by rolling injured or painful muscles and connective tissue on a pair of symmetrically positioned tennis balls or any massage balls (10) of roughly similar size including golf, lacrosse, hockey, baseballs or softballs. The embodiment's four tracks (2) permit the user to position one or more pairs of loose, freestanding round massage balls (10), so that a deep tissue massage may be performed on opposing sides of one or more body parts simultaneously. The tracks (2) also allow effortless ball changes to vary the size and hardness or to change the spacing between the balls for a highly individualized deep tissue massage particularly effective at relieving tender and painful connective tissue conditions including but not limited to back, foot, calf, chest, shoulder and arm ailments such as carpel tunnel syndrome and tendinitis. Other embodiments are described and shown.

### CROSS-REFERENCE TO RELATED APPLICATIONS

This application claims the benefit of provisional patent application Ser. No. 61/778,249, filed 2013 Mar. 12 by the present inventor.

### SEQUENCE LISTING

Not Applicable

### BACKGROUND

1. Field of Invention

This invention relates to self-massage, specifically deep tissue massage performed using tennis balls, massage balls or massage rollers.

2. Prior Art

Although deep tissue massage has helped people for thousands of years to recover from injuries by stimulating the healing process, researchers are just now finding proof of this at the molecular level. Deep tissue massage, however, is expensive and not everyone can afford it or find the time for an appointment with a massage therapist.

As a result, many people do their own self massage at home. In spite of the availability of countless massage tools, one of the most effective methods is still the simplest: lie down on a pair of tennis balls and roll around on them or roll your foot on top of a single tennis ball. As effective as the tennis ball method can be, it's difficult to do—the balls tend to squirm around. But controlling the movement, location and angle of applied pressure in massage is very important. Massage tool manufacturers have created countless tools that attempt to do this.

U.S. Pat. No. 5,577,996 to Gardner, et al. (1995) shows one common method where spheres are mounted on an axial rod with grip handles. Both U.S. Pat. No. 3,759,250 to Salata (1973) and U.S. Pat. No. 4,688,556 to Keller (1987) show a similar concept where rollers are held by a frame. Chen, in U.S. Pat. No. 5,531,665 (1996) shows massage balls strung along a cord.

Golfballmassage.com sells handheld cradles for golf balls that allow a massage therapist to manually perform a massage on clients with a golf ball. This device has the advantage of dispersing the pressure of the hard golf ball in the massage therapists palm.

The golf ball cradle and all the massage tools heretofore known suffer from a number of disadvantages:
(a) Their pressure surfaces come in fixed sizes necessitating the purchase of different tools when different body parts and injuries require a different size surface.
(b) Their pressure surfaces come with a fixed hardness necessitating the purchase of different tools when different body parts and injuries require softer or harder surfaces.
(c) Their pressure surfaces come with fixed spacing necessitating the purchase of different tools when different body parts and injuries require a wider or narrower distance between surfaces.
(d) As in the case of a foam roller, they offer a single surface which doesn't allow the user to treat opposing sides of a body part simultaneously, ie the extensors and flexors of the forearm.
(e) As in the case of the handheld golf ball cradle, they often require the use of the hands and arms which are sometimes afflicted with injury themselves. So a person attempting to do self-massage on the forearms who has bilateral injuries would be straining the same tissues that need therapy. Furthermore, many who suffer from muscle and connective tissue injuries, do not have the strength to do self-massage requiring aggressive use of the hands and arms.

What no formally developed massage tool offers, to my knowledge, is the ability to accurately and symmetrically position free rolling massage balls on opposing sides of a body part for an individualized, hands-free self-massage where the size, hardness, spacing, and angle of force of the pressure surface can be changed effortlessly in seconds.

### SUMMARY

The invention symmetrically positions a pair of freestanding massage balls so the user may perform a deep tissue massage by rolling opposing sides of a body part simultaneously while also allowing effortless ball changes to vary the size and hardness or to change the spacing between the balls. By changing the size and hardness of the massage balls, the user increases or decreases the pressure applied to the body and the depth of the massage. By changing the spacing of the balls, the user may target different muscle groups and vary the angle of pressure applied. More advantages will become apparent from a study of the following description and accompanying drawings.

### DRAWINGS

### Figures

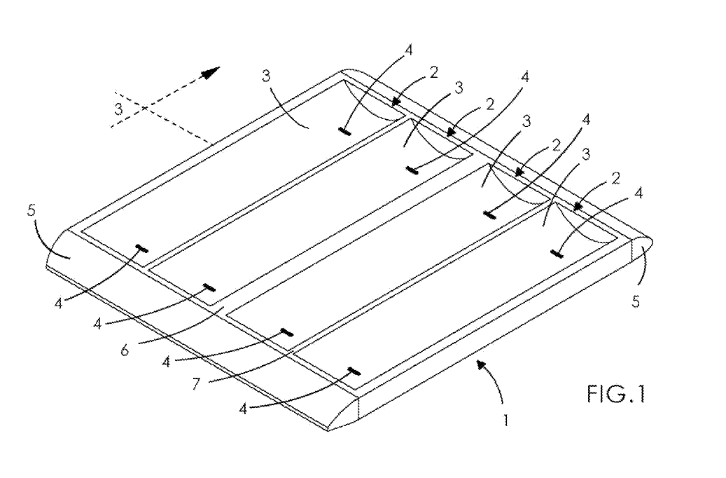

FIG. 1 is a perspective right side view of a massage device constructed in accordance with the invention.

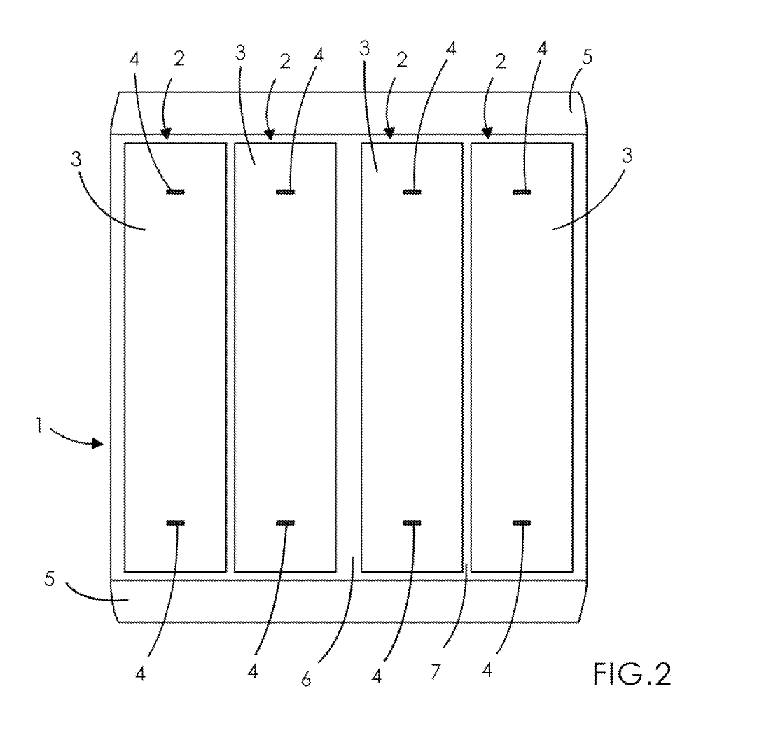

FIG. 2 is a topside view of the massage device of FIG. 1.

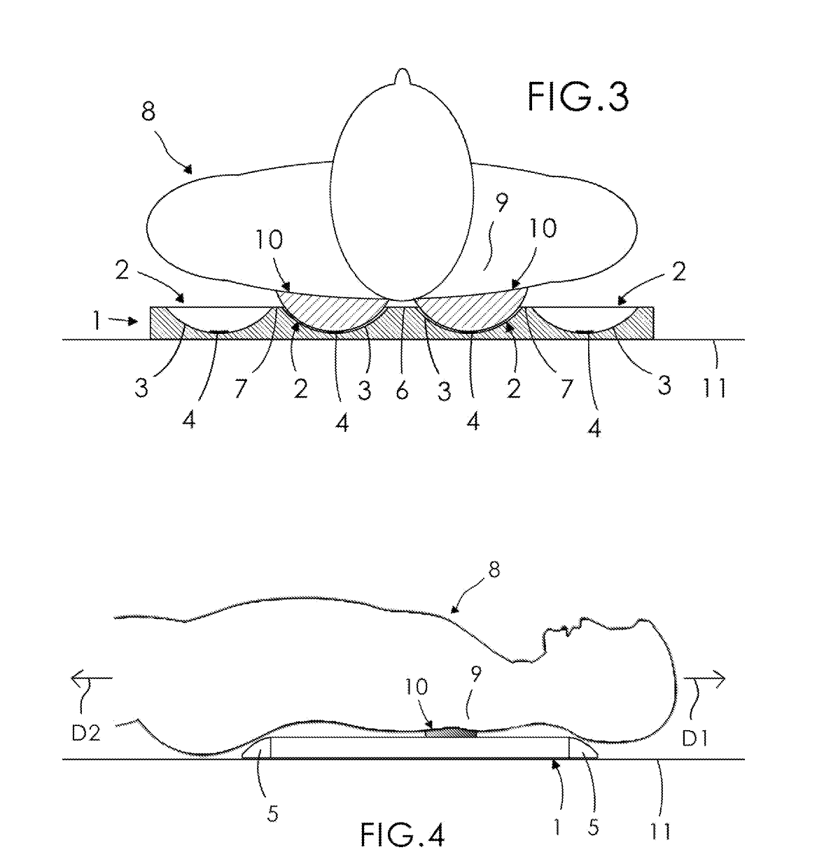

FIG. 3 is a lateral cross-section view of the massage device of FIGS. 1 and 2 showing a person using it to massage his back.

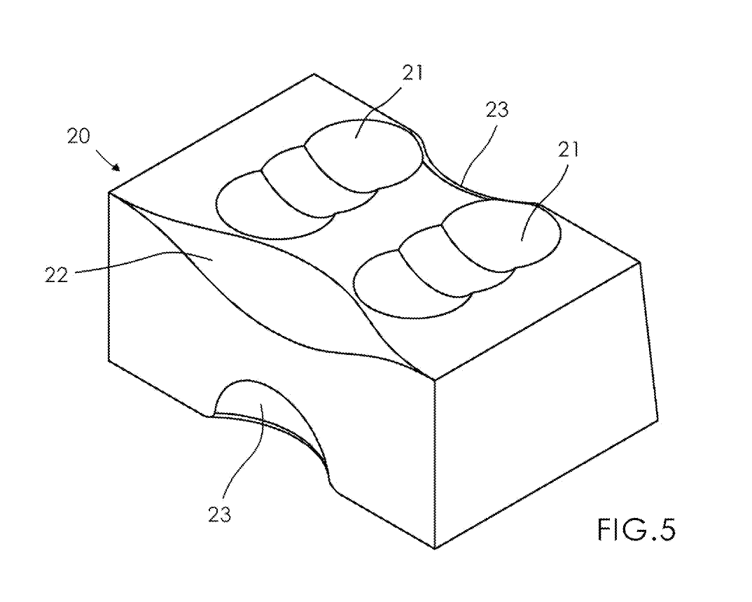

FIG. 4 is a side view of the massage device of FIG. 3.

FIG. 5 is a perspective right side view of a massage device constructed in accordance with the invention, specifically designed for massaging the neck.

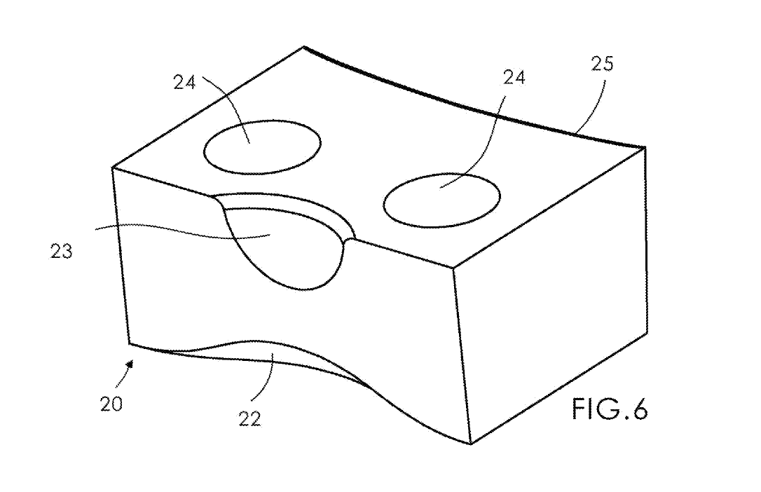

FIG. 6 is a perspective bottom and left side view of the massage device of FIG. 5.

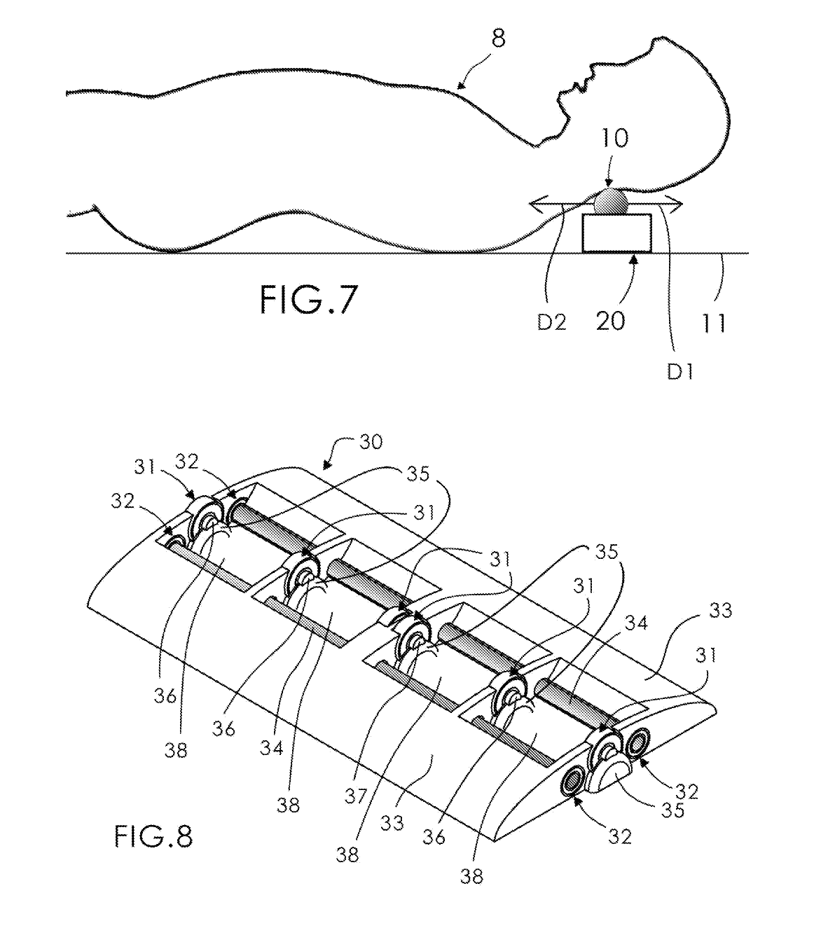

FIG. 7 is a side view of the massage device of FIG. 5 showing a person using it to massage his neck.

FIG. 8 is a perspective view of a massage device constructed in accordance with the invention designed to keep the balls in a fixed position using ball bearings and axles.

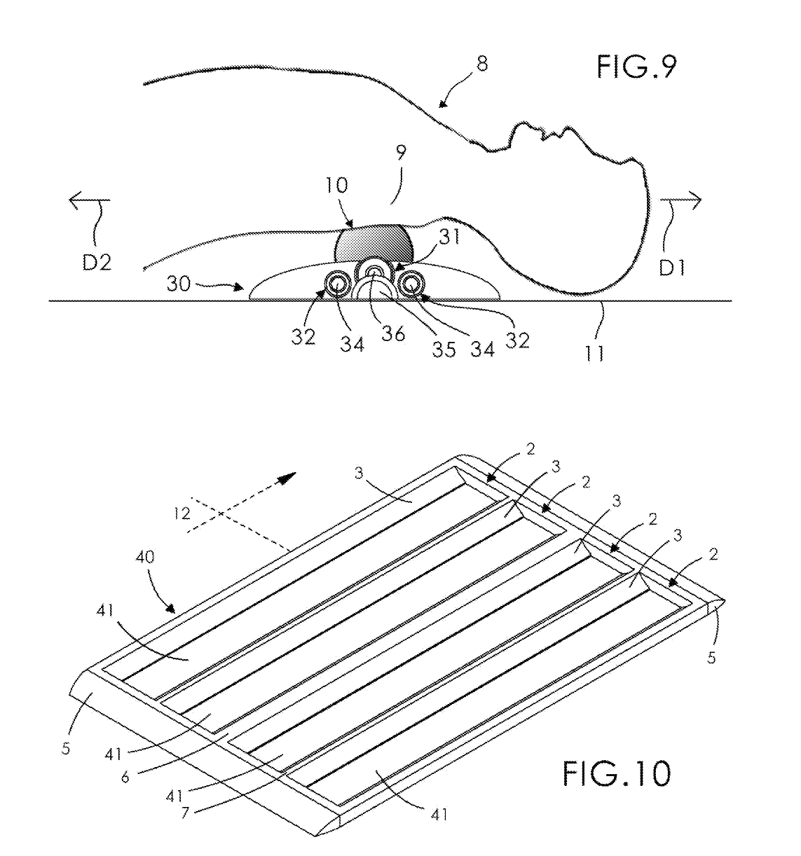

FIG. 9 is a side view of the massage device of FIG. 8 showing a person using the device to massage his back.

FIG. 10 is a perspective right side view of a massage device constructed in accordance with the invention, specifically designed for massaging the back.

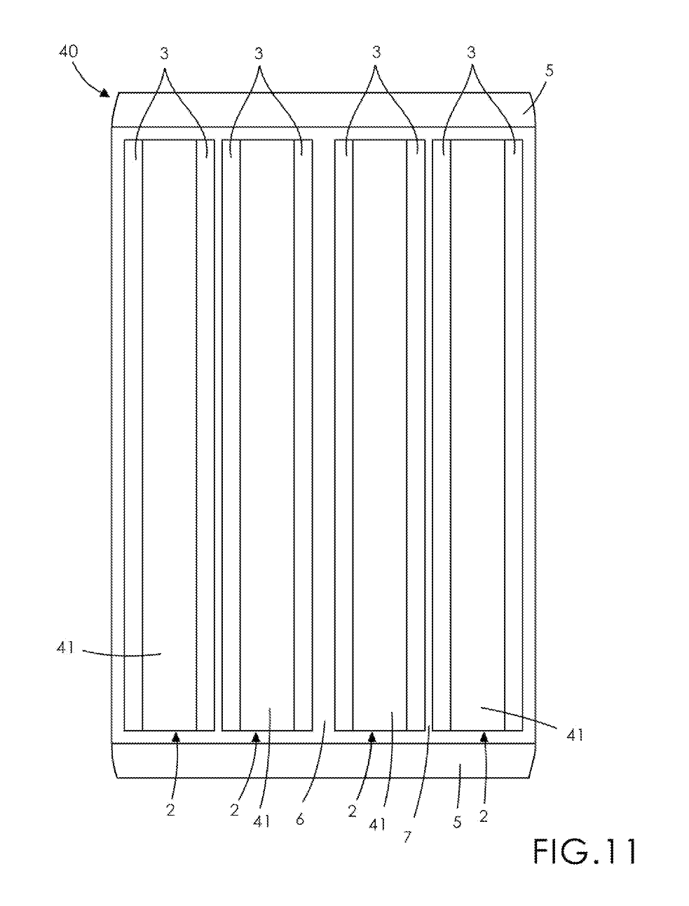

FIG. 11 is a topside view of the massage device of FIG. 10.

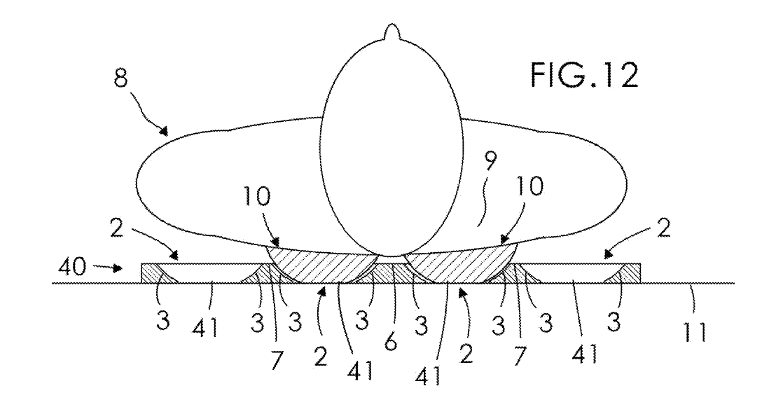

FIG. 12 is a lateral cross-section view of the massage device of FIGS. 10 and 11 showing a person using it to massage his back.

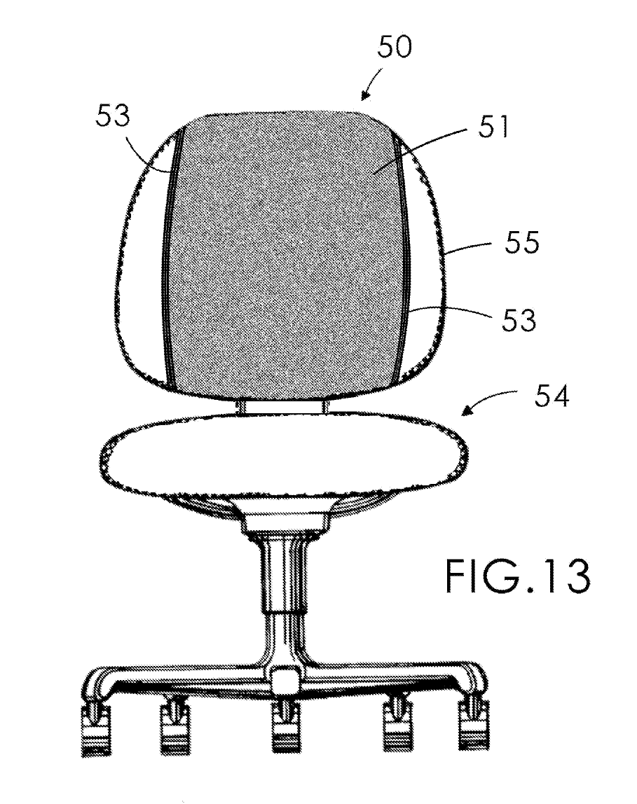

FIG. 13 is a front view of a massage device constructed in accordance with the invention, specifically designed for massaging the back using a chair back and two massage balls.

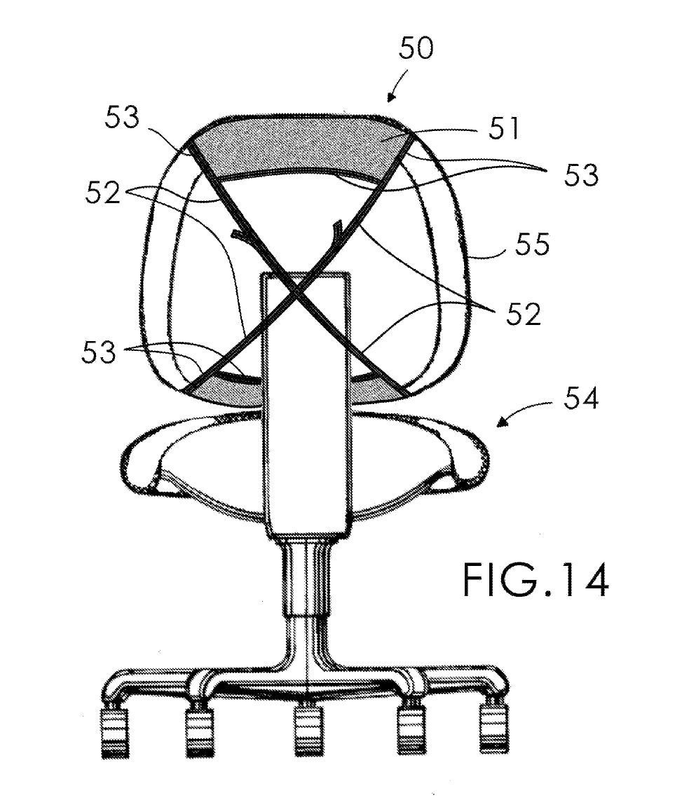

FIG. 14 is a backside view of the massage device of FIG. 13 showing the manner of attachment to the chair back.

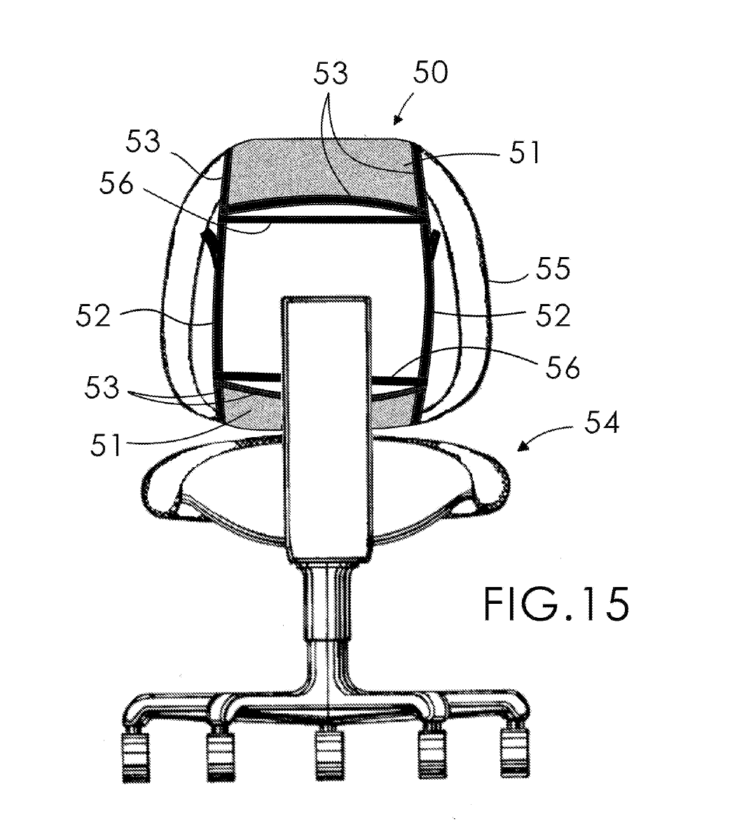

FIG. 15 is an additional backside view of the massage device of FIG. 13 showing an alternate method of attachment.

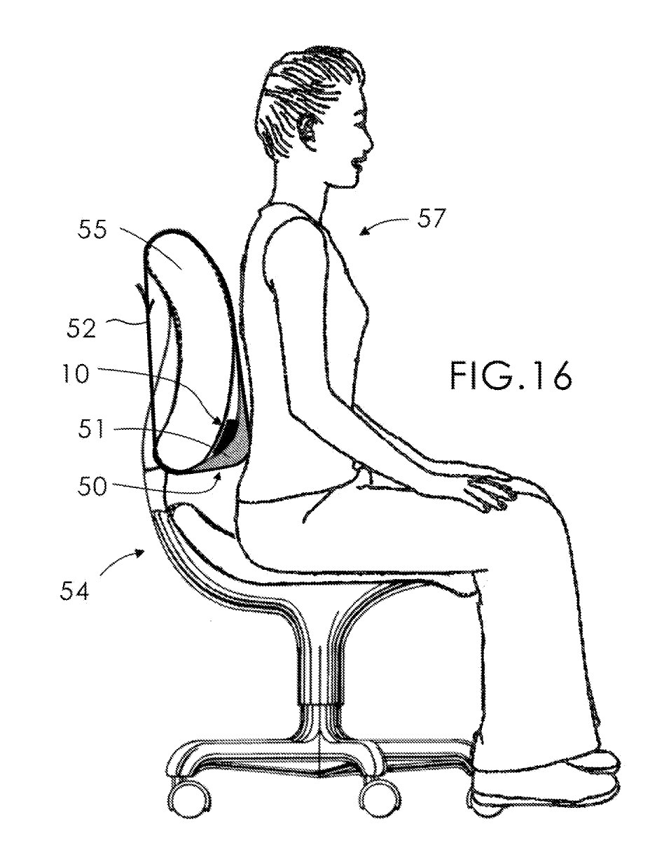

FIG. 16 is a side view of the massage device of FIG. 13 showing a woman sitting in the chair and using the device to massage her lower back.

### REFERENCE NUMERALS

1 massage device
2 massage ball track
3 track wall
4 ball-stop protrusion
5 sloped end
6 spacing between innermost tracks
7 spacing between inner and outer tracks
8 person
9 person's back
10 massage ball
11 floor
20 neck massage device
21 short concave massage ball track
22 headrest cutout
23 spinal column cutout
24 concave massage ball depression
25 shallow headrest cutout
30 massage device with axles
31 large roller bearing
32 small roller bearing
33 massage device body
34 long axle
35 axle support
36 short axle
37 medium axle
38 massage ball cavity
40 back massage device
41 track bottom cutout
50 elastic chair back or table massage device
51 elastic cloth
52 Velcro strap
53 elastic seam
54 chair
55 chair back
56 plastic spreader bar
57 woman
D1 forward direction of movement
D2 backward direction of movement

### DETAILED DESCRIPTION

### FIGS. 1-4—Preferred Embodiment

One embodiment of the invention is illustrated in FIG. 1 (perspective right side view). Massage device 1 is constructed of plastic, rubber, cork or similar material, in accordance with the invention. Each track 2 has walls 3 with a curvature that approximates the face of the round massage balls that roll against it, typically between 60 mm and 80 mm in diameter. Each track wall 2 also has a small ball-stop protrusion 4 at opposing ends preventing the massage ball from rolling away when placed at either end of track 2. Ball-stop protrusions 4 are typically 1 to 2 mm in height and 3 mm in width. Note that the space 6 in between the two innermost tracks 2 is wider (typically about 15 mm) than the outer spaces 7 between tracks 2 to accommodate a person's spine. The ends 5 of the massage device slope gently down.

FIG. 2 is a top view of the massage device of FIG. 1 showing the four tracks 2 with a wide space 6 between the inner tracks and the narrower space 7 between the inner and outer tracks. Each track 2 has a concave wall 3 creating a bed in which the massage balls may be rolled from end to end. The ends 5 slope down as seen in the perspective view of FIG. 1.

FIG. 3 is a lateral cross-section view of the massage device of FIGS. 1 and 2 showing person 8 using it on the floor 11 to massage his back 9 by rolling on massage balls 10 rolling in tracks 2. Wide space 6 is shown directly underneath person 8's spine and narrower space 7 falls roughly underneath the shoulder blades. Note ball-stop protrusion 4 is visible at the bottom of the two tracks that do not contain massage balls.

FIG. 4 is a side view of massage device 1 of FIG. 1 showing person 8 lying on the floor 11 and using it to roll the massage ball 10 up and down the person's back 9 by moving forwards and backwards following the directions of movement shown by arrows D1 and D2. Note sloped ends 5.

### Operation—FIGS. 1-4

In typical application the massage device 1 can be used to relieve pain and discomfort associated with muscular and other connective tissue ailments such as repetitive stress injuries of all types including carpel tunnel syndrome, tennis elbow or plantar fasciitis, for example.

Accordingly, in the event that a muscle in the back of a user 8 (FIGS. 3, 4, 9 and 12) is afflicted with pain or discomfort caused by stress and/or muscle spasm, for example, the user 8 places the massage device 1 on the floor with a massage ball 10 sitting at one end of each inner track 2. The user 8 then lies down on the ground and device 1 so that the massage balls sit underneath the afflicted muscle or tendon and rolls slowly backwards and forwards as indicated by the arrows, using the feet and/or hands and arms to push the body.

As the weight of the back 9 is applied against the massage balls 10 the muscles and tendons of the back flex and conform temporarily around the shape of the massage balls. The massage balls, in effect, are applying pressure, just as a human massage therapist would, which penetrates the belly of the muscle without damaging it. This pressure restores elasticity thus promoting healing and relief of pain and discomfort.

Optimal use of massage device 1 requires the user apply steady and continuous pressure in each afflicted area and surrounding areas for 15 to 60 seconds before rolling backwards or forwards.

This procedure is repeated as often as is necessary to relieve an affliction and eliminate the condition. This is usually at least once daily for 7 to 30 days but it will be appreciated by those skilled in the art that repeated use of the massage device 1 in the manner heretofore described is also effective in preventing additional occurrences of the pain or discomfort. Massage device 1 provides a safe and effective way for a person to manipulate muscle and connective tissue on his or her own, without the aid of a massage therapist.

Because massage device 1 has four tracks 2, the user 8 may vary the placement of the massage balls to target different areas of the back, for example by placing massage balls in the two outermost tracks or alternatively by placing a massage ball in an outermost track and the farthest innermost track so that one empty track separates the two massage balls.

Massage balls of varying hardness may also be used according to the needs of the user. Initially, when the user first starts using massage device 1, the muscles and connective tissue may be very sensitive calling for the use of a soft massage ball. As the muscles and connective tissue begin to heal and become less sensitive, a denser, harder massage ball will maximize the effectiveness of the massage treatment.

Massage balls of varying size may also be used according to the location of the tissues needing treatment. Smaller massage balls will reach more deeply into the body while larger massage balls are more appropriate for treating muscles and connective tissue that are closer to the surface.

It will be appreciated by those skilled in the art that the massage device 1 may be used to massage almost any part of the body in a substantially hands-free way, including but not limited to the back, abdomen, legs, forearms or feet, in the manner heretofore described.

For example, in an alternative manner of use, massage balls may be placed in all four tracks to massage both forearms or both feet at the same time. To massage both feet, the user 8 would place the massage device 1 at the foot of a couch and roll each foot backwards and forwards over a pair of massage balls sitting in an inner and outer track. This spacing causes the massage balls to deliver pressure at a 45° angle perfectly suited to reaching deeply inside the arch of the foot.

Alternatively, each foot may be rolled over a single massage ball sitting in the outer tracks. To massage the forearms, the massage device 1 is placed on a table with a massage ball in each track and the forearms rolled backwards and forwards sandwiched in the spans between massage balls.

### FIGS. 5-16—Additional Embodiments

FIG. 5 is a perspective right side view of a massage device 20 constructed of foam, plastic, rubber, cork or similar material, in accordance with the invention, and specifically designed for massaging the neck but also highly effective on the abdominal muscles and gluteals. Note the concave shape of the tracks 21. Note cutout 23 prevents the spinal column from touching the device 20 more than necessary. An even larger cutout 22 supports the back of the person's head.

FIG. 6 is a perspective bottom and left side view of the massage device 20 of FIG. 5. Note the bottom features two concave depressions 24 for cupping massage balls with a wider spacing than the tracks on the top surface. These cups hold the massage balls in place and do not allow the massage balls to roll. The bottom side also shows a cutout 23 for the neck. The bottom has a shallow head support 25 (the top-side head support 22 shown in FIG. 5 is partially visible in this view also).

FIG. 7 is a side view of the massage device 20 of FIG. 5 showing a person 8 using it on the floor 11 to massage his neck. Person 8 will move the massage ball 10 backwards and forwards following the direction of movement arrows D1 and D2, lifting his head slightly to do so and using his hands to periodically roll the massage ball 10 to a new position along its track.

FIG. 8 is a perspective view of a massage device 30 constructed of plastic or similar material, in accordance with the invention, designed to keep the balls in a fixed position using ball bearings and axles. The body 33 supports two full-length axles 34 supported by small roller bearings 32 at each end of the device. The long axles 34 support massage balls allowing them to rotate freely. Larger bearings 31 are placed on either side of each massage ball cavity 38 and held by axles 36 and 37 which are held in place by supports 35. The large bearings 31 prevent massage balls from slipping out sideways from the cavity 38 but also assist in rotating the massage ball. The front and back of body 33 are sloped gently to make the massage device comfortable.

FIG. 9 is a side view of massage device 30 of FIG. 8 sitting on the floor 11 showing a person 8 using the device to massage his back 9 by rolling on ball 10 as he moves his body forwards and backwards in directions D1 and D2. In the side view, the small roller bearings 32 are shown holding long axles 34. Axle support 35 is also visible in the center underneath large bearing 31 and supporting a short axle 36.

FIG. 10 is a perspective right side view of a massage device 40, constructed in accordance with the invention, specifically designed for massaging the back and constructed of plastic, rubber, cork or similar material. Each track 2 has walls 3 with a curvature that approximates the face of the massage balls that roll against it, typically between 60 mm and 80 mm in diameter. Each track 2 also has a bottom cutout 41 to allow massage balls to sit on and roll freely on the floor. Note that the space 6 in between the two innermost tracks 2 is wider (typically about 15 mm) than the outer spaces 7 between tracks 2 to accommodate a person's spine. The ends 5 of the massage device slope gently down for comfort.

FIG. 11 is a top view of the massage device of FIG. 10 showing the four tracks 2 with a wide space 6 between the inner tracks and the narrower space 7 between the inner and outer tracks. Each track 2 has a concave wall 3 creating a bed in which the massage balls may be rolled from end to end. Each track 2 also has a bottom cutout 41 to allow massage balls to sit on and roll freely on the floor. The ends 5 slope down as seen in the perspective view of FIG. 10.

FIG. 12 is a lateral cross-section view of the massage device of FIGS. 10 and 11 showing person 8 using it to massage his back 9 by rolling on massage balls 10 which roll in tracks 2. Note that in this embodiment of the invention, the massage balls touch the floor 11 because of track bottom cutout 41. Wide space 6 is shown directly underneath person 8's spine and narrower space 7 falls roughly underneath the shoulder blades.

FIG. 13 is a front view of a massage device 50 constructed in accordance with the invention, specifically designed for massaging the back using a chair back 55 or massage table and two massage balls held in place between the chair back or table surface and the device 50. The device is constructed of an elastic cloth 51 whose edges are sown inside a thicker elastic seam 53. The width of the device may typically vary from 165 mm to 267 mm wide and the length is approximately 84 cm allowing both ends to wrap around the back of the backrest on most chairs.

FIG. 14 is a backside view of the massage device of FIG. 13 showing the manner of attachment to the chair back using Velcro straps 52 which are sewn onto the elastic seam 53. The Velcro straps are typically 30 cm long. The straps can either be crisscrossed in the back of the chair as shown in FIG. 14 or used vertically as shown in FIG. 15 depending on the size and shape of the chair back and which arrangement results in the tightest fit.

FIG. 15 is an additional backside view of the massage device of FIG. 13 showing an alternate method of attachment using two spreader bars 56 made of a stiff plastic and a vertical attachment of the Velcro straps 52. The spreader bars are solid round plastic tubes typically 8 to 10 mm in diameter and 16.5 cm to 26.7 cm which fit into pockets sewn into the elastic seam 53. Each spreader bar is 1.5 cm longer than the width of the device in its unstretched state at the corresponding end (top or bottom) in which it fits to provide some tension on the pocket ends to prevent it from slipping out. Although the Velcro straps are shown attaching vertically in this drawing, they may also be crisscrossed (with the spreader bars in place) as shown in FIG. 14.

FIG. 16 is a side view of the massage device of FIG. 13 showing a woman 57 sitting in the chair 54 and using the device to massage her lower back. The woman 57 is applying pressure against two massage balls 10 held in place by elastic cloth 51. She has placed each ball touching the other with her spinal cord in between so that neither ball touches her spine. The massage balls 10 are effectively sandwiched in between the elastic cloth 51 and the backrest 55. The tension required to keep a tight fit between the backrest and the elastic cloth 51 is achieved by tightening the Velcro straps 52.

### ADVANTAGES

From the description above, a number of advantages of some embodiments of my massage device become evident:
(a) It allows the user to find just the right degree of pressure and depth of penetration for each body part or injury by selecting an appropriate massage ball and changing as frequently as necessary.
(b) For those already doing massage with tennis balls, it gives them much better control of the massage by channeling the path of the balls.
(c) For those already doing massage with tennis balls, it allows them to apply pressure diagonally to target previously inaccessible tissues such as the arch of the foot, sides of the ankle and calf etc. (this is a result of the diagonal resistance force of the track wall, when a pair of massage balls are used symmetrically on the opposing outside edges of a body part).
(d) It allows those who need deep tissue massage and already own golf, hockey, lacrosse, tennis or softballs, to buy fewer massage devices.
(e) The use of symmetrically placed massage balls allows for a comfortable and balanced deep tissue massage which can be performed while relaxing or watching TV.
(f) The use of symmetrically placed massage balls allows the user to massage two sides of a body part simultaneously offering a more complete massage in less time.
(g) The ability to simultaneously roll a pair of massage balls, of roughly 40 to 80 mm diameter, from one end of the device to the other, allows the user to treat a large expanse of tissue with a significant amount of pressure in a short time.
(h) By increasing the height of the device as in the embodiment shown in FIGS. 5-7, a number of additional body parts can be massaged with great effectiveness including the neck, abdominal muscles (psoas), and gluteals (piriformis).

### CONCLUSION, RAMIFICATIONS, AND SCOPE

Accordingly, the reader will see that the ability of the various embodiments to control the positioning of loose, freestanding massage balls has additional advantages in that:
it can be used to perform a highly individualized deep tissue massage according to the momentary needs of the user and specific body part being worked on;
the ability to apply the right amount of pressure at the right depth and in the right place with minimal effort makes this device more effective than existing options;
its great versatility allows the user to perform effective deep tissue massage on a wide variety of body parts including the feet, calves, shins, hamstrings, quadriceps, hips, abdominals, mid, lower and upper back, neck, chest, shoulders, forearms and triceps.

Although the description above contains many specificities, they should not be construed as limiting the scope of the embodiment but as merely providing illustrations of some of the presently preferred embodiments. For example, the tracks shown can have other shapes, using flat or convex walls, be vertical or angled and the track bottoms can be flat or perforated with holes, notched or ridged to create additional ball resting positions. Furthermore, additional embodiments may use smaller or larger tracks and depressions for use with golf balls, softballs or other useful sizes.

Thus the scope of the embodiment should be determined by the appended claims and their legal equivalence, rather than by the examples given.

While the preferred embodiments of the invention have been described above, it will be recognized and understood that various modifications can be made in the invention and the appended claims are intended to cover all such modifications which may fall within the spirit and scope of the invention.

I claim:

1. A method of massage, comprising:
a) placing a pair of massage balls in the depressions or tracks of, or under the fabric of a massage device resting on a stable surface;
b) disposing a massageable portion of a body on said pair of massage balls in opposed relation about said portion of a body;
c) generating travel on said pair of massage balls on said massagable portion of said body;
d) massaging said massageable portion of said body.

2. A massage device comprising:
(a) a device body having a sufficient size and shape to substantially prevent movement of the device with respect to the surface on which it is resting,
(b) an elastic cloth or plurality of tracks, spherical depressions or axles by which a plurality of freestanding massage balls may be symmetrically positioned or rolled symmetrically and simultaneously along a user's body and the massage device,
(c) wherein said tracks or spherical depressions have a predetermined symmetrical spacing to accommodate said user's spinal column and or other body parts such as feet, forearms and neck in between said massage balls,
whereby (a) said user of said massage device can accurately position and control the movement of symmetrically placed tennis or other massage balls to (b) apply strong and steady, controlled pressure on opposing sides of his body parts (c) in a substantially hands-free manner, (d) while allowing for quick and easy changes of massage balls (harder, softer, larger, smaller) and their spacing (closer together or further apart).

3. The massage device of claim 2 wherein said tracks or said depressions each have a width or diameter of between about 1.375 inches and about 3.5 inches.

4. The massage device of claim 3 wherein said tracks or said depressions each have a depth of between about 0.25 inches and about 1.5 inches.

5. The massage device of claim 4 wherein said tracks or said depressions are spaced between about 0.25 inches and about 3.5 inches apart.

6. The massage device of claim 5 wherein said device body is made of ethylene vinyl acetate (EVA).

7. The massage device of claim 6 wherein said device body is made of polyurethane.

8. The massage device of claim 7 wherein said device body is made of natural rubber.

9. The massage device of claim 8 wherein said device body is made of cork.

10. The massage device of claim 5 wherein the height of the device is between about 0.25 inches and about 1.5 inches.

11. The massage device of claim 10 wherein said device body has Shore A hardness of between about 30 and about 98.

12. The massage device of claim 5 wherein the height of the device is between about 2 inches and about 3.25 inches.

13. The massage device of claim 12 wherein said device body has Shore C hardness of between about 2 and about 65.

14. The massage device of claim 13 wherein said device body has a recess for receiving and supporting the back of said user's head.

15. The massage device of claim 13 wherein said device body has a recess for receiving and protecting said user's spinal column.

16. The massage device of claim 2 further comprising ball positioning means at both ends of said tracks for preventing said massage balls from rolling away before said user applies pressure on top of said massage balls.

17. The massage device of claim 2 wherein said device body has gently sloping ends.
